(19) United States
(12) Patent Application Publication
(10) Pub. No.: US 2007/0168154 A1
(43) Pub. Date: Jul. 19, 2007

(54) User interface for statistical data analysis

(76) Inventor: Richard E. Ericson, Cannon Falls, MN (US)

Correspondence Address: 3M INNOVATIVE PROPERTIES COMPANY, PO BOX 33427, ST. PAUL, MN, 55133-3427, US

(21) Appl. No.: 11/317,375

(22) Filed: Dec. 23, 2005

(51) Int. Cl. G06F 19/00

(52) U.S. Cl. 702/179

(57) ABSTRACT

In general, the invention is directed to data exploration and visualization techniques. In one embodiment, the invention provides a method comprising accessing Multivariate Curve Resolution data having a plurality of components to identify a set of combinations of the components, wherein each of the combinations includes at least two of the components; and presenting a user interface having an input region associated with each of the combinations, wherein each of the input regions has a visual indicium generated as a function of a degree of correlation between components in the respective combination.

### FIELD

This invention relates generally to statistical data analysis and, more particularly, user interfaces for statistical data analysis systems.

### BACKGROUND

Multivariate statistical analysis concerns using various techniques to find correlations between multivariate data, in which each data point has more than one scalar component. Two statistical techniques used in multivariate statistical analysis include Principal Component Analysis (hereinafter PCA) and Multivariate Curve Resolution (hereinafter MCR).

PCA is a commonly used technique for simplifying a dataset. For example, one main application of PCA is to reduce the number of variables used to represent a data set by detecting structure in the relationships between the variables, so as to classify variables. Specifically, PCA is a linear transformation that chooses a multidimensional coordinate system for a dataset such that the greatest variance by any projection of the dataset comes to lie on the first axis (then called the first principal component), the second greatest variance on the second axis, and so on. PCA can be used for reducing dimensionality in a dataset while retaining characteristics of a dataset that contribute most to its variance by eliminating later principal components. The results of PCA are orthogonal score vectors (eigenspace coordinates) and loading vectors (eigenvectors).

MCR is often employed in conjunction with PCA. MCR concerns techniques that identify response profiles of components in a multivariate dataset. More particularly, MCR is an iterative resolution process that seeks to derive factors (also referred to as resolved components) that more closely resemble true constituent factors. This may be accomplished by applying one or more constraints such as, for example, non-negativity, unimodality and closure during the factorization process. Applying constraints does not necessarily guarantee that physically meaningful factors will result. Rather, the constraints only reduce the number of possible solutions. In some applications, resolved components are calculated by starting with a PCA model where the data components are orthogonal to each other, then applying least squares fitting procedures alternately and repeatedly to spectra and concentrations until the results for both converge.

Many software programs that provide MCR do not readily allow for the combination of highly correlated components, forcing the analyst to rely on mental combination of components, or forcing the analyst to pre-select components to include or exclude based on the eigenvalue plot from PCA, evolving factor analysis (EFA), or other means, or by redoing lengthy calculations until results are satisfactory. Such processes are complicated further by the fact that components removed by the analyst must be taken into account during the iterative alternating least squares (ALS) procedure that is part of the MCR process. Even in software that allows for combining resolved components, this functionality is typically accomplished via a menu operation or by a manual method such as typing instructions for the mathematics required for doing matrix computations. Consequently, combining components is usually reserved for those with mathematical or statistical backgrounds, and is not otherwise easily accomplished.

### SUMMARY

In general, the invention is directed to data exploration and visualization techniques that allow a user to more easily apply multivariate statistical analysis to a dataset. As one example, data exploration and visualization software is described that allows a user to more easily perform Principal Component Analysis (PCA) in conjunction with Multivariate Curve Resolution (MCR). The data exploration and visualization software provides a user interface that allows the user to graphically and interactively explore the dataset using both techniques.

In one embodiment, the invention provides a method comprising accessing MCR data (data generated from a dataset by MCR) having a plurality of components to identify a set of combinations of the components, wherein each of the combinations includes at least two of the components; and presenting a user interface having an input region associated with each of the combinations, wherein each of the input regions has a visual indicium generated as a function of a degree of correlation between components in the respective combination.

In another embodiment, the invention provides a computer-implemented system comprising a module executing on the computer system to access MCR data having a plurality of components and correlation data for combinations of components; and a module executing on the computer system to present a user interface having an input region associated with each of the combinations, wherein each of the input regions has a visual indicium generated as a function of a degree of correlation for the respective combination.

In a further embodiment, the invention provides a computer-readable medium comprising instructions for causing a programmable processor to access MCR data having a plurality of components; identify at least one set of combinations of the plurality of components, wherein each of the combinations includes at least two of the components calculate the degree of correlation between each of the components in each combination; and present a user interface having an input region associated with each of the combinations, wherein each of the input regions has a visual indicium generated as a function of a degree of correlation for the respective combination.

In another embodiment, the invention provides a method comprising accessing MCR data having a plurality of components; and presenting a user interface with a graphical display of the MCR data, wherein one or more of the components may be individually selected by clicking corresponding visual indicia.

The invention may provide one or more advantages. For example, the invention may allow a user to select and analyze components based on a visual representation of the degree of correlation between component pairs. Once selected, the system may present the user with additional information related to the correlation of the selected components, and an interface facilitating a decision as to whether to combine the individual components. Once a user has determined multiple components should be combined, the invention may allow for automatic combination of these components, without the user needing to perform additional steps. This may allow for simplified interaction with the computer to carry out desired analysis.

Further, the invention may allow an analyst to quickly and simply see important correlations, then easily experiment with combining the underlying components. It may allow the analyst to over-select the number of starting components, then work backwards to the correct number through the process of combination.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a block diagram illustrating an exemplary statistical data analysis system in which a computing device incorporates a data exploration/visualization module in accordance with embodiments of the invention.

FIG. 2 is a block diagram illustrating an exemplary embodiment of the data computing device of FIG. 1 in further detail.

FIG. 3 is a flowchart illustrating exemplary operation of the statistical data analysis system.

FIG. 4A is a flowchart illustrating exemplary operation of the data exploration/visualization module of FIG. 1 when constructing a user interface having a factor correlation matrix that provides visual indicia representing a degree of correlation between each resolved component pair.

FIG. 4B is a flowchart illustrating exemplary operation of the data exploration/visualization module of FIG. 1 when automatically identifying data clusters by auto-coloring all PCA cluster scatter plots.

FIGS. 5-21 are exemplary screen illustrations from a user interface presented by the data exploration/visualization module of FIG. 1.

FIG. 22 illustrates in further detail an exemplary factor correlation matrix constructed by the data exploration/visualization module to provide visual indicia representing a degree of correlation between each resolved component pair.

FIG. 23 illustrates in further detail an exemplary PCA scatter plot auto-colored via MCR autocoloring by the data exploration/visualization module.

### DETAILED DESCRIPTION

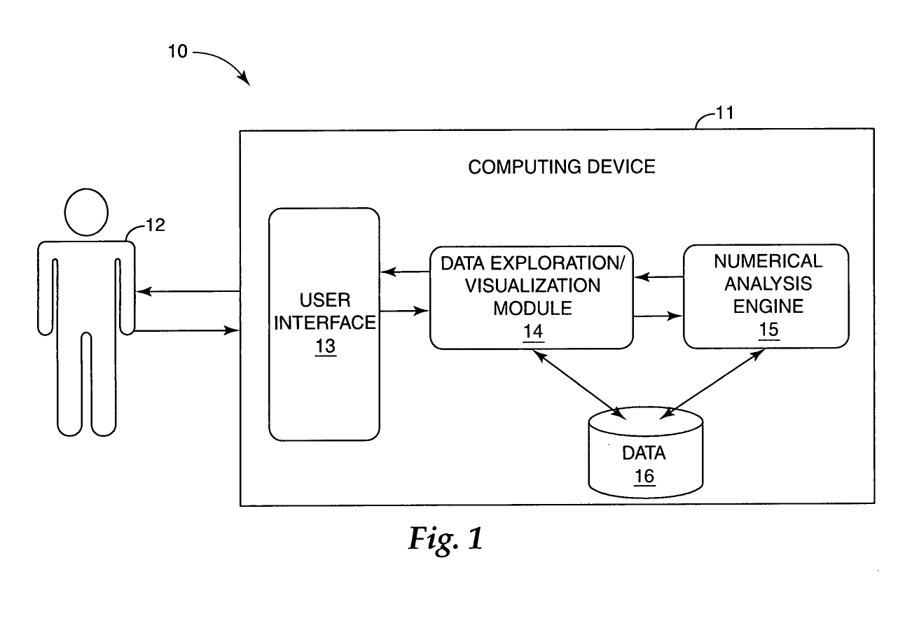

FIG. 1 is a block diagram illustrating an exemplary statistical data analysis system 10 in which computing device 11 implements data exploration and visualization software that may allow user 12 to more easily apply multivariate statistical analysis to multivariate data. As one example, computing device 11 provides an operating environment for data exploration and visualization software module 14 that, in one embodiment, allows user 12 to more easily perform statistical analysis on data 16.

In the exemplary embodiment of FIG. 1, computing device 11 includes a user interface 13 presented by data exploration/visualization module 14, a numerical analysis engine 15, and data 16. Data exploration/visualization module 14 presents user interface 13 with which user 12 interacts to perform multivariate statistical analysis on data 16. In response to input provided by user 12, data exploration/visualization module 14 invokes numerical analysis engine 15 to transparently and seamlessly carry out data analysis (e.g., PCA and MCR) on data 16.

For example, in one embodiment, numerical analysis engine 15 presents an application programming interface (API) and provides a computational environment for complex statistical analysis, such as application of PCA and MCR. Data exploration/visualization module 14 invokes numerical analysis engine 15 to apply statistical techniques to data 16 under the direction of user 12 and, in response, receives various descriptive information associated with data 16. In this manner, numerical analysis engine 15 interacts with data 16 in response to instructions from data exploration/visualization module 14. These instructions may direct, for example, numerical analysis engine 15 to perform various statistical functions for computing resolved components. The data or pointers to the data may either be passed directly back to data exploration/visualization module 14 by way of the API or may be placed in a common data repository, such as data 16.

Data exploration/visualization module 14 graphically presents results from the analysis by way of user interface 13, which allows user 12 to view the results and interactively explore the statistical results. Moreover, data exploration/visualization module 14 may further analyze and process the statistical results produced by numerical analysis engine 15 in order to produce a meaningful representation of the results in a form that is more readily usable by user 12. As discussed herein, data exploration/visualization module 14 and user interface 13 provide a graphical, interactive environment having numerous features that allow user 12 to more easily perform the multivariate statistical analysis on data 16.

In one embodiment, data exploration/visualization module 14 and user interface 13 construct a graphical representation of the degrees of correlation between resolved components and allow user 12 to readily inspect and/or combine any resolved components, particularly those having high correlation. For example, data exploration/visualization module 14 may instruct user interface 13 to include a graphical display having an interactive matrix (grid), wherein the intersecting rows and columns represent the degrees of correlation between each combination of the resolved components using visual indicia, such as coloring and/or shading. In this manner, user interface 13 allows user 12 to easily identify those resolved components having high degrees of correlation. User 12 may view further statistical details relating to any combination of the resolved components and elect to combine any of the components by selecting any cell of the graphical matrix.

In another embodiment, data exploration/visualization module 14 graphically renders each of the resolved components produced by the MCR analysis, and allows user 12 to individually select any of the components to view further information related to that particular component.

As yet another example, data exploration/visualization module 14 and user interface 13 produce coordinated PCA and MCR scatter plots using an intelligent, auto-coloring approach. As discussed in further detail below, data exploration/visualization module 14 and user interface 13 renders the PCA and MCR scatter plots in a manner that may allow user 13 to more easily relate principal components identified during PCA with resolved components generated from the MCR analysis.

In this manner, data exploration/visualization module 14 and user interface 13 provide a graphical, interactive environment having numerous features that allow user 12 to more easily perform multivariate statistical analysis on data 16. These and other features are discussed in further detail below.

User interface 13 may take any form of graphical user interface (GUI), and may comprise, for example, various windows, control bars, menus, switches, radio buttons, or other mechanisms that facilitate presentation of data 16 and interaction with user 12. One common exemplary user interface is provided by the WINDOWS™ Operating System from Microsoft Corporation. Although described with respect to direct user interaction, user 12 may also remotely access computing device 11 via a client device. For example, user interface 13 may be a web interface presented to a remote client device executing a web browser or other suitable networking software. Moreover, although described with respect to user 12, data exploration/visualization module 14 may be invoked by a software agent or another computer or device programmed to interact with user interface 13 or an application programming interface (API) provided by the data exploration/visualization module.

Numerical analysis engine 15 may be implemented in a variety of ways. For example, the numerical engine may be provided by one or more dynamic link libraries (DLL) that allow other software application programs to access and invoke the computational functionality provided by the numerical analysis engine. An exemplary numerical analysis engine is MATLAB™ numerical analysis engine by MathWorks of Natick, MA, which is a data-manipulation software package that allows data to be analyzed and visualized using functions and user-designed programs. Alternatively, the functionality of numerical analysis engine 15 could be implemented by the data exploration/visualization module 14. Moreover, numerical analysis engine 15 need not physically reside within computing device 11. For example, data exploration/visualization module 14 could invoke numerical analysis engine 15 over a private or public network, such as the Internet.

In general, data 16 represents one or more raw datasets for analysis by numerical analysis engine 15. In addition, data 16 includes any results produced from the analysis as well as any parameters or other configuration data required by data exploration/visualization module 14. In some embodiments, data 16 may include, for example, raw images, PCA concentration profiles (obtained by a factorization of the data under an orthogonality constraint), or MCR concentration profiles (obtained by a factorization of the data under a non-negativity or other constraint). Data 16 may be stored in a variety of forms including data storage files, or one or more database management systems (DBMS) executing on one or more database servers. The database management system may be a relational (RDBMS), hierarchical (HDBMS), multidimensional (MDBMS), object oriented (ODBMS or OODBMS) or object relational (ORDBMS) database management system. Data 16 could, for example, be stored within a single relational database such as SQL Server from Microsoft corporation.

Computing device 11 typically includes hardware (not shown in FIG. 1) that may include one or more processors, volatile memory (RAM), a device for reading computer-readable media, and input/output devices, such as a display, a keyboard, and a pointing device. Computing device 11 may be, for example, a workstation, a laptop, a personal digital assistant (PDA), a server, a mainframe or any other general-purpose or application-specific computing device. Although not shown, computing device 11 may also include other software, firmware, or combinations thereof, such as an operating system and other application software. Computing device 11 may read executable software instructions from a computer-readable medium (such as a hard drive, or a CD-ROM), or may receive instructions from another source logically connected to computer, such as another networked computer.

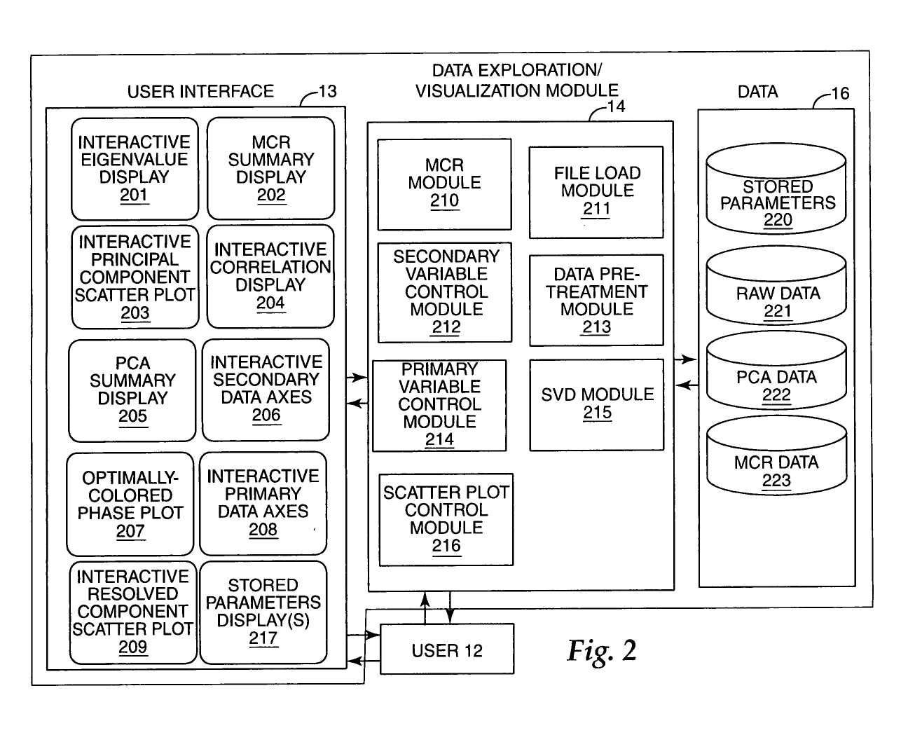

FIG. 2 is a block diagram illustrating an exemplary logical embodiment of a portion of computing device 11 with which user 12 may interact to more easily perform Principal Component Analysis (PCA) in conjunction with Multivariate Curve Resolution (MCR) on data 16. Particularly, FIG. 2 illustrates an exemplary embodiment of an operating environment provided by computing device 11 for data exploration/visualization module 14, user interface 13, and data 16. This exemplary embodiment includes modules, user interface components, and data repositories useful to one skilled in the art. It will be understood that features and functionality not specifically ascribed to a sub-module exist generally within user interface 13, data exploration/visualization module 14, or data 16. For illustrative purposes, FIG. 2 does not explicitly illustrate numerical analysis engine 15, but it is to be understood that any of the modules of data exploration/visualization module 14, user interface 13, user 12, or data 16 may interact with numerical analysis engine 15 as necessary to access functionality contained within numerical analysis engine 15.

In the exemplary embodiment of FIG. 2, data exploration/visualization module 14 includes an MCR module 210, a file load module 211, a primary variable control module 212, a data pre-treatment module 213, a secondary variable control module 214, a singular value decomposition (SVD) module 215 and a scatter plot control module 216. As described below, these software modules operate to generate portions of user interface 13, including an interactive eigenvalue display 201, a MCR summary display 202, an interactive principal component scatter plot 203, an interactive correlation display 204, a PCA summary display 205, an interactive secondary data axes 206, an optimally colored phase plot 207, an interactive primary data axes 208, an interactive resolved component scatter plot 209, and a stored parameters display(s) 217. The interaction and relationship between the modules of data exploration/visualization module 14 and the components of user interface 13 are explained in further detail below.

In general, file load module 211 opens, parses, and loads the contents of a file or other collection of data into data 16. In one embodiment, user 12 provides file load module 211 with information specifying the location of the data file, then file load module 211 requests the file be opened, and subsequently pareses and loads the data. For example, a user may provide file load module 211 with a directory path and filename that specifies the location of the data file, which is subsequently opened by file load module 211 and parsed. The file need not be local to a system or a local area network, however. Rather, user 12 could specify a network address, for example. File load module 211 may also receive the data directly (rather than receiving input identifying the raw data's file location) through various communication means, including operating system piping calls, programming interfaces or other techniques. File load module 211 parses the data file to ensure that the data conforms with various data integrity rule sets. For example, file load module 211 may check the contents of the file to ensure the data is formatted correctly. File load module 211 then loads the data file into data 16, and more specifically into raw data 221.

File load module 211 may also be programmed to load data representing intermediate or other process steps, to avoid work redundancy or preserve state information. For example, the data opened or received by file load module 211 may be coupled with pre-selected, pre-calculated eigenvectors, in which case user 12 would not be required to re-select eigenvectors of interest via interactive eigenvalue display 201.

Data pre-treatment module 213 may use pre-existing stored parameters 220 to inspect and apply various rule sets and transformations to the data, and otherwise prepare the data for subsequent analysis. Stored parameters 220 may include various data, including a selection of one or more pre-processing algorithms and MCR algorithm parameters.

Singular value decomposition (SVD) module 215 receives pre-treated data from data pre-treatment module 213 and uses a linear algebra technique to factorize data into a set of principal components. In so doing, the singular value decomposition module 215 invokes numerical analysis engine 15 to process raw data 221 to produce the set of principal components. SVD module 215 presents to user 12 via user interface 13, and particularly the interactive eigenvalue display 201 of user interface 13, an interactive eigenvalue display. Interactive eigenvalue display 201 allows user 12 to select a range of eigenvalues for use in constructing a PCA model of the data (hereinafter PCA data) 222, which is a subset of the principal components. Consequently, PCA data 222 may be defined via the SVD module's analysis, coupled with user 12's selection of eigenvectors of interest.

Data exploration/visualization module 14 may provide to user 12 via PCA summary display 205 a view of PCA data 222. As illustrated below, PCA summary display 205 graphically summarizes and presents the PCA data 222.

User 12 may invoke various processes and procedures on PCA data 222. In one embodiment, user 12 may invoke via user interface 13 the MCR module 210, using stored parameters 220 to calculate and populate MCR data 223. For example, in response to direction from user 12, MCR module 210 may invoke numerical analysis engine 15 to perform MCR statistical analysis on PCA data 222 to produce MCR data 223 having a plurality of resolved components. Alternatively, this functionality may be native to MCR module 210.

Data exploration/visualization module 14 provides numerous features that allow user 12 to visualize the resolved components of the MCR data 223. For example, data exploration/visualization module 14 may provide to user 12 via MCR summary display 202 a view of MCR data 223. In particular, MCR summary display 202 may graphically present and summarize the components of MCR data 223 generated from PCA data 222.

As one example, interactive secondary data axes 206 displays to user 12 a visual display of MCR data with individually selectable components computed by MCR module 210 in conjunction with numerical analysis engine 15. The components may be selected by user 12 by selecting an area of the interactive secondary data axes 206 that corresponds to the selectable component. Once user 12 selects a component of the interactive secondary data axes 206, MCR module 210 causes further information about the selected component to be displayed to user 12 via interactive primary data axes 208.

Primary and secondary variable correlation modules 212 and 214 may use MCR data 223 and may work in tandem to calculate relative correlations between pairs of primary components (scores) and pairs of secondary components (loadings). These two modules may then display, via interactive correlation display 204, a grid or matrix that graphically represents degrees of correlation between various pairs of primary components and pairs of secondary components of MCR data 223. A portion of the interactive correlation display combines the contributions of both primary component correlation and secondary component correlation into a total component correlation according to a functional relationship. In one embodiment, data exploration/visualization module 14 may produce the graphical display as an interactive matrix or grid in which intersecting rows and columns represent relative correlation between each combination of the primary and secondary components using visual indicia, such as coloring and/or shading. The term primary component represents the resolved scores of the MCR data and the term secondary component represents the resolved loadings of the MCR data. One skilled in the art will recognize that other indicia could also be used, including but not limited to any visual, audio, or sensory signal that can convey relative degree-type information to user 12.

In one embodiment, user interface 13 and particularly interactive correlation display 204 outputs the factor correlation matrix as an interactive display region that allows user 12 to select any combination of resolved components of resolved data 223 by selecting with a mouse or pointing device an area corresponding to the intersection of resolved components. Once two components of interest have been selected by user 12 via user interface 13 and interactive correlation display 204, user 12 may inspect the two components, and determine whether the components show a data profile such that it would be advantageous to combine the components. User 12 may indicate his desire to combine components to the data exploration/visualization module 14 via user interface 13. Once data exploration module 14 receives notice from user 12 via user interface 13 that two or more of the resolved components should be combined, data exploration/visualization module 14 directs numerical analysis engine 15 to combine the components, and then may re-invoke MCR module 210 to re-calculate and re-populate MCR data while treating the two combined components specially, or as one. Alternatively, the data exploration/visualization module may make changes to PCA data 222, raw data 221, or stored parameters 220 based on the feedback from user 12 via user interface 13, then request numerical analysis engine 15, via MCR module 210, to re-populate and re-calculate MCR data 223. In this manner, data exploration/visualization module 14 and user interface 13 provide a graphical, interactive environment having numerous features that allow user 12 to more easily perform the multivariate statistical analysis on data 16, including easily analyzing both PCA data 222 and MCR data 223.

As another example of the interactive features of data visualization/exploration module 14, MCR module 210 may display to user 12 via interactive secondary data axes 206 and interactive primary data axes 208 various information about raw data 221 once PCA data 222 and MCR data 223 are calculated. For example, in one embodiment, secondary data axes 206 displays to user 12 a bounded chromatogram, while interactive primary data axes 208 displays a bounded total ion mass spectrum.

As another example, scatter plot control module 216 may facilitate the use of PCA data 222 and resolved components of MCR data 223 to automatically identify phases and then display an optimally colored representation of these phases via optimally-colored phase plot 207. In one embodiment, scatter plot control module 216 produces interactive principal component scatter plot 203 and optimally colored phase plots (also referred to herein as MCR scatter plots) in an automated or semi-automated fashion. As described in further detail, scatter plot control module 216 provides the automated or semi-automated identification of data clusters associated with two or more components of MCR data 223 generated from PCA data 222 by Multivariate Curve Resolution (MCR). Scatter plot control module 216 then renders a principal component scatter plot, such as principal component scatter plot 203, using the data clusters identified from the MCR data. In this manner, scatter plot control module 214 provides to user 12 via interactive principal component scatter plot 203 a view of PCA data 222 wherein principal components are graphically represented along axes, automatically identified, and auto-colored in a manner that takes advantage of the fact that within MCR scatter plots, data clusters tend to lie largely in predictable locations (along the axes) and are of measurable size (the length of the axis).

Scatter plot control module 216 may perform this process by first rendering a plurality of MCR scatter plots, wherein each MCR scatter plot represents a different combination of the components. Scatter plot control module 216 then repeatedly assigns colors to the data along the axes of the MCR scatter plots in the order of variance contribution to resolved components selected by user 12, moving progressively through the scatter plots from the least significant pair to the most significant pair. This approach provides over-coloring of pixels with more significant components. Data exploration/visualization module 14 allows the user 12 to switch back and forth between PCA data 222 and MCR data 223.

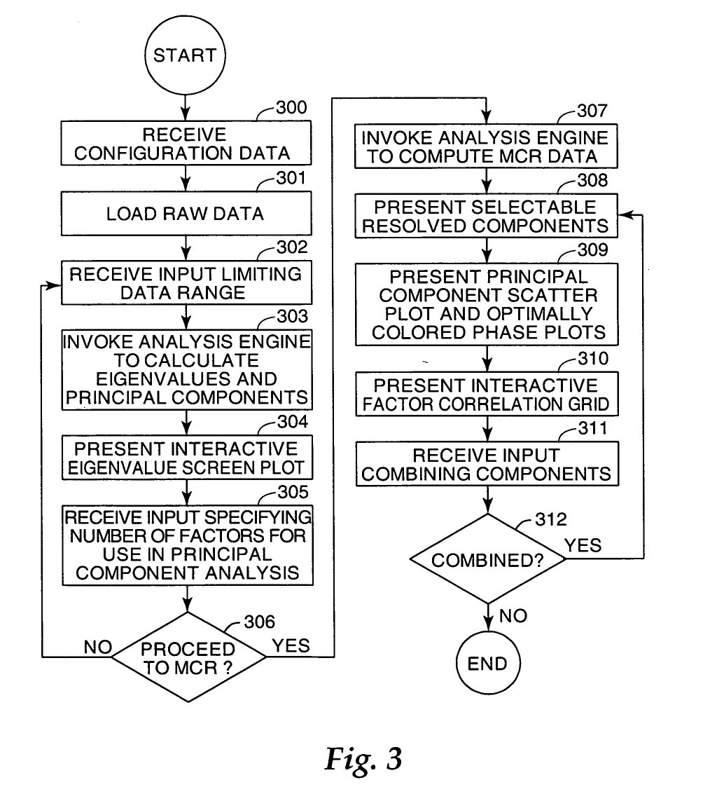

FIG. 3 is a flowchart illustrating an example high-level interaction between user 12 and computing device 11 when performing statistical data analysis in accordance with embodiments of the invention. Initially, computing device 11 receives configuration data (300). As described above, this may be done by computing device 11 soliciting various information from user 12 via user interface 13. For example, user 12 may indicate the type of information to be loaded, the type of operation to be performed, or both. The configuration data loaded initially could be any information necessary or helpful in pre-configuring computing device 11 for subsequent analysis and operations.

Next, file load module 211 loads raw data 221 (301). Preliminary analysis may be done on the data to present information to user 12 that may be useful for limiting the data range. It is at this point that data pre-treatment module 213 uses stored parameters 220 to apply rule sets to the semi-processed data. Of particular note, the data at this point may be analyzed and displayed in a visual manner that allows user 12 to circumscribe, using a mouse or other pointing device, a range of data that user 12 would like to focus subsequent analysis upon (302). As one example, this selection may be done by user 12 via user interface 13 by dragging a rectangle over a visual representation of the data to define a range of interest.

With a sub-range of data selected, computing device 11 next invokes numerical analysis engine 15 to calculate eigenvalues and principal components on the selected range of data (303), and populate PCA data 222. SVD module 215 next presents interactive eigenvalue display 201 that visually represents the computed principal components (304). Upon inspection, user 12 may indicate a particular set of components of the PCA data 222 that are to be used in subsequent MCR analysis (305). In this way, user 12 can graphically define the eigenvectors of interest for subsequent analysis and PCA data 222 is further defined.

User 12 may continue interacting with data exploration and visualization software module 14 to further limit the dataset or proceed to MCR analysis (306). If user 12 elects to further limit and inspect the PCA data 222, user 12 may continue to iterate through the process by interacting with the graphical interface provided by data exploration and visualization software module 14 until he has precisely pinpointed the data range and principal components of interest. Throughout the process, data exploration and visualization software module 14 transparently invokes numerical analysis engine 15 to recompute and update PCA data 222 as necessary.

Once user 12 is comfortable with the reduced data set, user 12 directs system 11 via user interface 13 to proceed to MCR analysis (306). In response, data exploration and visualization software module 14 transparently invokes MCR module 210 to perform MCR on the defined portion of PCA data 222. MCR module 210 uses stored parameters 220 and PCA data 222, and invokes various procedures from numerical analysis engine 15, to compute MCR data 223 having a plurality of resolved components (307).

Next, user interface 13 displays selectable resolved components (308). In particular, user 12 is presented with a PCA summary display 205 and a MCR summary display 202, which summarize MCR data 223 and the computed resolved components. User 12 may interact with user interface 13 presented by data exploration and visualization software module 14 in a variety of ways to seamlessly switch between PCA analysis mode and MCR analysis mode. For example, user 12 may visually explore the PCA data 222 and the MCR data 223 via the interactive secondary data axes 206 and the interactive primary data axes 208. User interface 13 presents to user 12 a screen showing pre-identified components in secondary data axes 206, which may be selected or highlighted by clicking corresponding visual indicia. Once selected, data exploration/visualization module 14 provides to user 12 further information about the component in interactive primary data axes 208.

As another example, user 12 may elect to view one or more scatter plots of PCA data 222 and the MCR data 223. In response, data exploration and visualization software module 14 invokes scatter plot control module 216 to automatically identify and color phases, and render optimally-colored phase plot 207 and interactive resolved component scatter plot 209 for user 12 (309).

As yet another example, user 12 may inspect information presented via interactive correlation display 204 that, as described, is produced by secondary variable control module 212 and primary variable control module 214 to provide a visual indication of the degree of correlation between each of the resolved components (310). User 12 may inspect combinations of resolved components by clicking on visual indicia within the interactive correlation display 204, and provide further input regarding possible combination of selected components (311). If user 12 elects to combine two or more resolved components (NO of 312), then data exploration and visualization software module 14 re-computes the MCR data 223 and user 12 may continue to analyze PCA data 222 and MCR data 223 by seamlessly switching from a PCA mode and an MCR mode until the user concludes his interaction with the system (YES of 312).

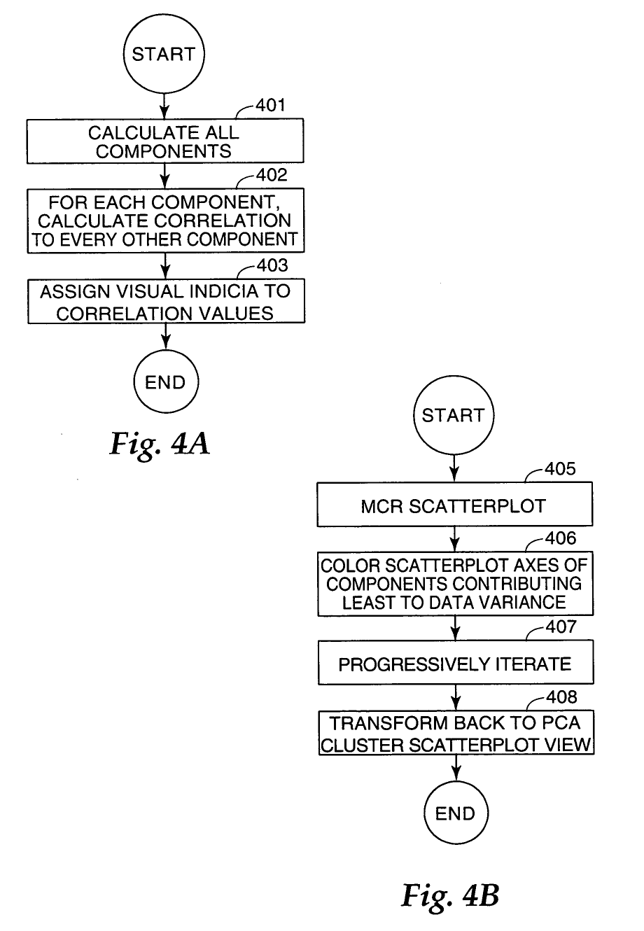

FIG. 4A shows a flowchart illustrating exemplary operation of the data exploration/visualization module of FIG. 1 when constructing a user interface having a factor correlation matrix that provides visual indicia representing a degree of correlation between each resolved component pair. Particularly, FIG. 4A shows exemplary operation of secondary variable control module 212 and primary variable control module 214 constructing and displaying interactive correlation display 204 to present visual indicia, in the form of points of color or shades of color, arranged in the form of a grid or matrix, regarding factor correlation to user 12.

Initially, data exploration/visualization module 14 starts with a calculation of all components, which may have been previously completed and stored in MCR data 223 (401). If resolved components have not been calculated, secondary variable control module 212, primary variable control module 214, or other modules may invoke modules, such as the MCR module 210 or numerical analysis engine 15 directly, to calculate the initial set of resolved components using MCR.

Once all resolved components have been calculated (401), secondary variable control module 212 and primary variable control module 214 interact to calculate a correlation value for each combination of resolved components (402). In one embodiment, this is accomplished by iterating through each resolved component and invoking numerical analysis engine to determine correlations to every other component. Once secondary variable correlation control module 212 and primary variable control module 214 have calculated correlations between each of the resolved components, secondary correlation control module 212 and primary variable control module 214 assign visual indicia to the correlations (403).

Assignment of visual indicia to factor correlation values 403 may be done by assigning different visual indicia to different factor correlation values or ranges of values. For example, higher degrees of correlation may be assigned a designated color or shading, while lower degrees of correlation may be a different color or shading. Special ranges of correlation could be assigned specific colors or shades. In another embodiment, the assignment of visual indicia to factor correlation values may be in absolute terms if user 12 determines negative and positive factor correlations are equally interesting. In general, the assigned visual indicia could take the form of any type of graphical icon, label or other indicator. Rather than visual indicia, the data exploration/visualization module 14 could also be programmed use some other type of indicia compatible with a different sensory mechanism of user 12, such as sound or touch.

Once assignment of visual indicia to factor correlation values is complete, data exploration/visualization module 14 generally, and secondary variable control module 212 and primary variable control module 214 more specifically, display to user 12 via interactive correlation display 204 an organization of the visual indicia assigned in 403 (310). In one embodiment, the visual indicia are displayed to user 12 in the form of a two dimensional matrix or grid. The X and Y axis represent resolved components, and visual indicia for the corresponding combinations of components are displayed at intersecting points within the grid. There are other ways in which visual indicia could be displayed, such as a three dimensional graph, or a spectrum, or any other graphical manner useful for juxtaposing data elements.

While FIG. 4A concerns correlation between resolved components, the same procedure could be used to present a useful visual display of correlation between any set of variables. As one example, and in another embodiment, the invention employs similar means to calculate and display correlations between time (1106) and mass (1107).

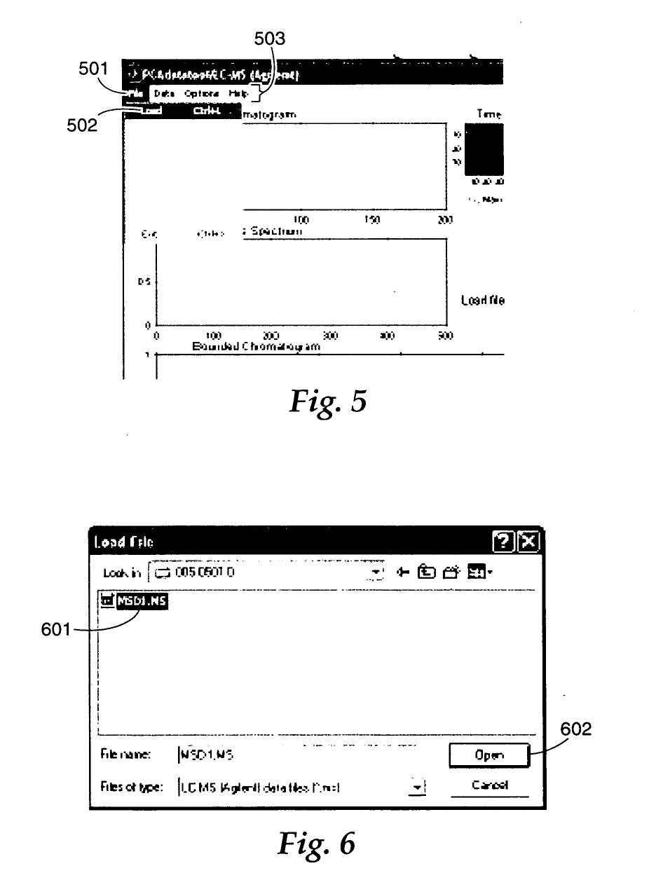

FIG. 4B is a flowchart illustrating exemplary operation of the data exploration/visualization module of FIG. 1 when automatically identifying data clusters by auto-coloring all PCA cluster scatter plots. Particularly, FIG. 5 shows an example embodiment in which scatter plot control module 216 displays to user 12 via interactive resolved component scatter plot 209 a scatter plot in which components have been automatically identified by scatter plot control module 216 and auto-colored.

Initially scatter plot control module 216 computes MCR scatter plots for each combination of components (405). The resulting MCR scatter plots have clusters that lie largely in predictable locations (along the axes) and are of measurable size (the length of the axis). Scatter plot control module 216 assigns visual indicia to each identified cluster, for each combination. In this way, clusters are identified for every combination of components.

Next, starting with components contributing least to data variance (406), the visual indicia assigned to the clusters in the MCR scatter plot are plotted in a PCA scatter plot. The visual indicia could be any indicia that can show degree, such as shades of a color. Next, scatter plot control module 216 progressively overlays visual indicia of clusters of components increasingly contributing to data variance (407). In so iterating, scatter plot control module 216 overlays pixels associated with more significant components such that the more significant components visually dominate lesser components. In this way, individual component clusters are automatically identified by computing device 11. Scatter plot control module 216 then allows user 12 to switch between an MCR and PCA cluster scatter plot view (408) while preserving the coloring assigned in aforementioned steps. The user is then able to switch to PCA mode and manually provide adjustments to the coloring of PCA scatter plots. Additionally, the user may color portions of PCA scatter plots that are uncolored because data points lie off-axis in the MCR domain. The user may then repeat the PCA scatterplot adjustments as needed.

The approach to automatically identifying clusters flowcharted in FIG. 4B may be beneficial over other approaches that use orthogonal data components produced by PCA. In such approaches, a user would use a mouse or other pointing device to manually circumscribe identifiable clusters within one or more of the two-dimensional scatter plots associated with the principal pairs, causing the computer to selectively color those pixels and the corresponding pixels within the images. With such an approach, clusters tend to be of variable sizes and locations within the scatter plot axes and may overlap, and are thus difficult to manually circumscribe with accuracy and confidence. The approach flowcharted in FIG. 4B uses MCR scatter plot techniques to provide an initial identification or classification of PCA clusters.

FIGS. 5-21 are exemplary screen illustrations from a user interface presented by the data exploration/visualization module of FIG. 1.

FIG. 5 shows an exemplary embodiment in which user 12 is preparing to invoke file load module 211 via user interface 13. In this example, user 12 selects File 501 from menu bar 503, and then selects load 502 from the pull down menu.

FIG. 6 shows the file load module 211 displaying a dialog to user 12 via user interface 13 information about files that may be opened. After user 12 selects a file, in this case file 601, the user may press the Open button 602, to indicate to file load module 211 that the file has been selected and may now be further processed.

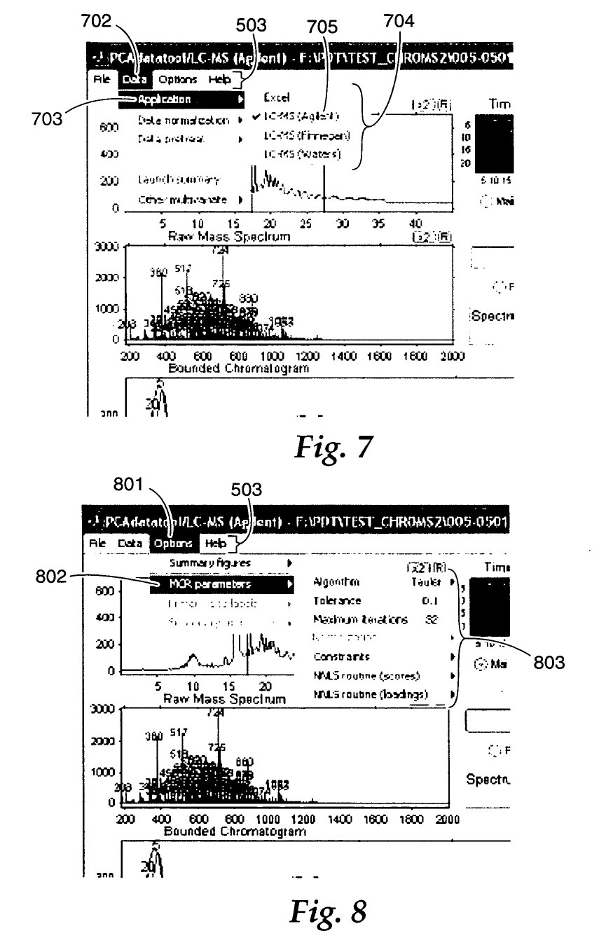

FIG. 7 and FIG. 8 show data pre-treatment module 213 and SVD module 215 driving various interfaces via user interface 13.

FIG. 7 shows the user interface 13 after user 12 has selected Data 702 from menu 503, then further selected Application 703. User 12 is presented with several choices 704 for the data application to be used. User 12 may change the data application to be used via this dialog either before or after raw data 221 has been loaded via file load module 211. If file data application 704 is changed after raw data 221 has been loaded via file load module 211, computing device 11 may automatically recalculate PCA data 222 and resolved components 223.

FIG. 8 shows the user interface 13 after user 12 has selected Options 801 from menu 503, then further selected MCR parameters 802 from the drop down menu options. FIG. 8 shows how various MCR algorithm and constraints may be modified via user interface 13.

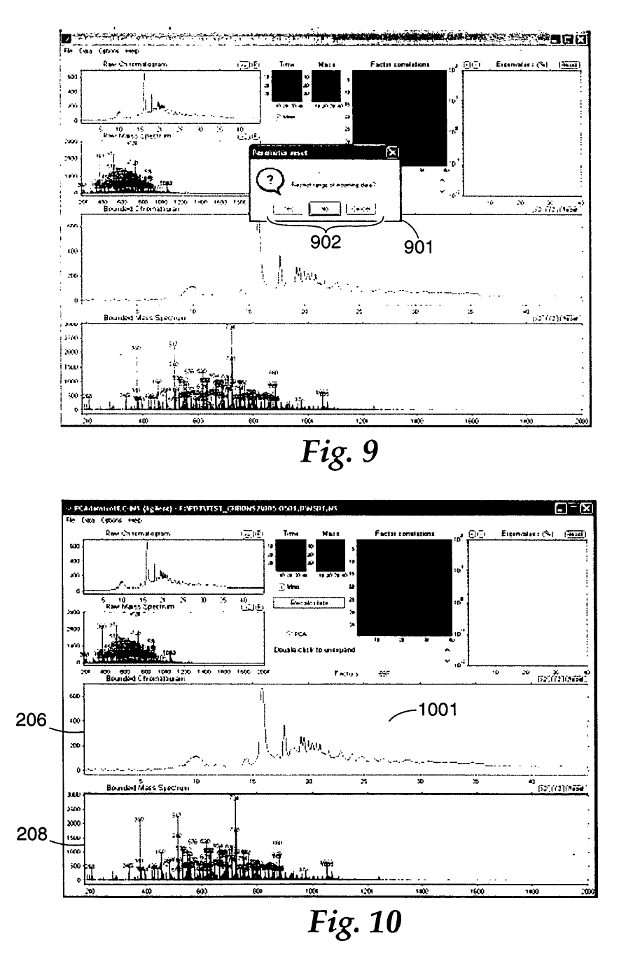

FIG. 9, FIG. 10, and FIG. 1 show user interface 13 facilitating limiting of the data range to a subset of the whole, which speeds up subsequent processing.

FIG. 9 shows dialog 901 confirming user 12's desire to restrict the range of incoming data. User is presented with several options 902, one of which is affirmative.

FIG. 10 shows user interface 13 facilitating data limiting by allowing user 12 to select, via a mouse or other pointing device, a subset of the entire data range displayed in interactive secondary data axes 206 by circumscribing with square 1001. In this example, user 12 is selecting a range within bounded chromatogram window, which is the interactive secondary data axes 206. User 12 could also choose to limit mass spectrum boundaries via the same process applied to the bounded mass spectrum window 1003, which is the interactive primary data axes 208.

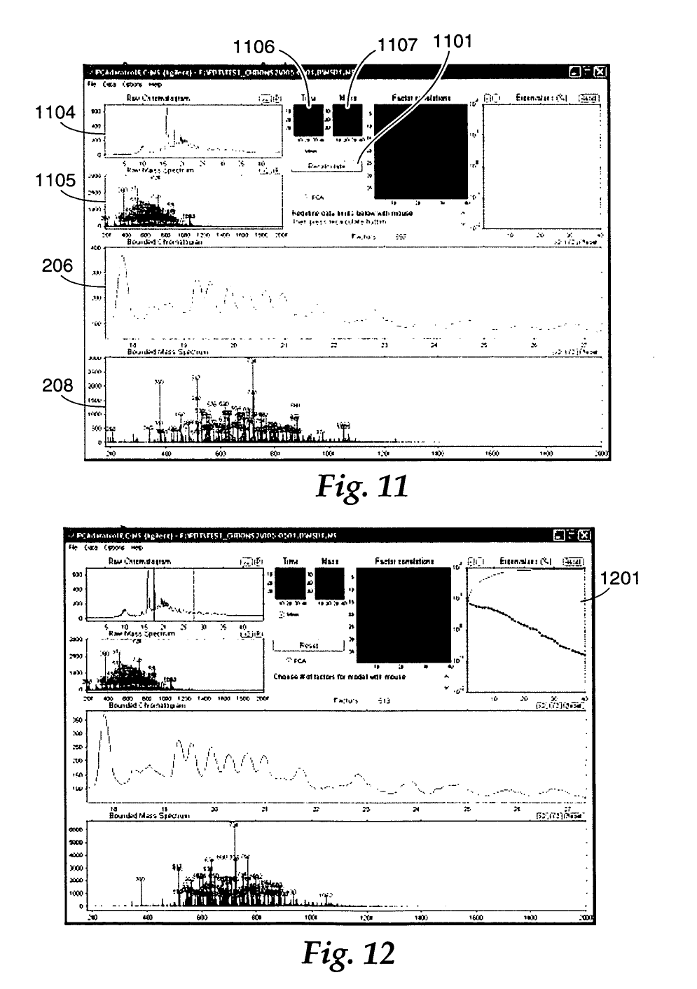

FIG. 11 shows user interface 13 after user 12 has selected a subset of data as described in FIG. 10. Interactive secondary data axes 206 shows a bounded chromatogram of the circumscribed data. Interactive primary data axes 208 shows a bounded mass spectrum window that has not changed, because in this example user 12 did not choose to limit the bounded mass data. Note that Raw Chromatogram window 1104 continues to show the entire data population, even though the active data has been limited in 1002. Raw mass spectrum window 1105 would exhibit similar functionality had bounded mass spectrum in primary data axes 208 been limited. In this example, bounded mass spectrum in primary data axes 208 was not limited, so raw mass spectrum 1105 and bounded mass spectrum 1003 are similar.

FIG. 12 shows user interface 13 after user 12 has pressed recalculate button 1101. The recalculate button 1101 invokes SVD module 215 to calculate eigenvalues and display interactive eigenvalue display 1201.

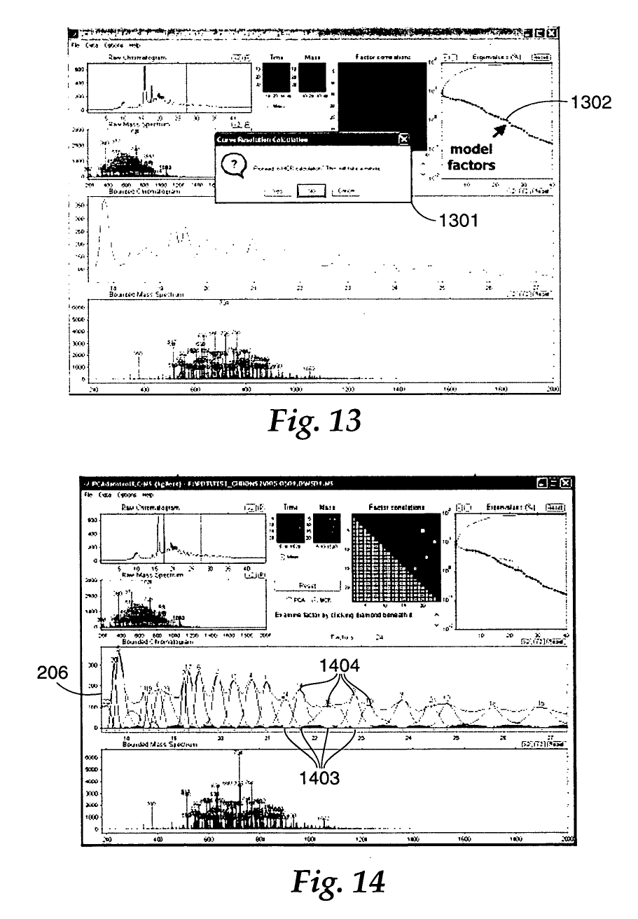

FIG. 13 shows user interface 13 displaying confirmation dialog 1301 after user 12 has selected a range of eigenvalues of interest from interactive eigenvalue display 1201 by clicking on model factor 1302. All eigenvalues to the left of (less than, on the x-axis) model factor 1302 selected will then be used if user 12 selects “yes” to confirmation dialog 1301. In this manner, eigenvalues of interest may be quickly, graphically, and easily selected. Once a factor is selected, the user interface provides visual indicia of selected components by lightly shading the graph area corresponding to lower x-axis values. Once user 12 selects “yes” to confirmation dialog 1301, data exploration/visualization module 14 may recalculate MCR data 223.

FIG. 14 shows user interface 13 displaying raw data 221 with MCR data 223 using the eigenvalues selected in FIG. 13. Data exploration/visualization module 14 has calculated components of interest and marked each one with a corresponding visual indicia, in the form of an icon (1403). Each pre-calculated component has also been numbered (1404).

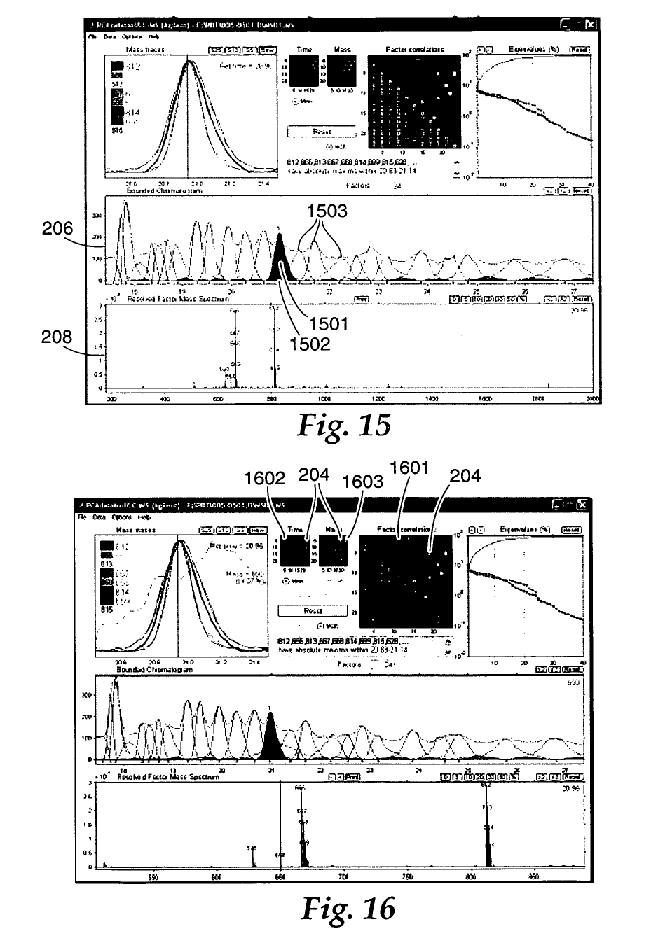

FIG. 15 shows user interface 13 after user 12 has selected a factor of interest in interactive secondary data axes 206 showing bounded chromatogram by clicking a corresponding indicator 1403, in this case 1502. Once clicked, the corresponding area in interactive secondary data axes 206 showing the bounded chromatogram is darkened (1501), and the corresponding numbers for those components not selected are faded (1503). Interactive primary data axes 208 now displays resolved component mass spectrum for the selected component (1501).

FIG. 16 shows user interface 13, and particularly three interactive correlation displays 204. Here, factor interactive correlation display 1601 takes the form of a matrix or grid, wherein correlation between components is represented by visual indicia (shading, coloring, or otherwise) at the corresponding intersecting cell. User 12 may select a cell in the matrix to examine the correlation between pairs of components or examine further information about the individual components themselves. User 12 may similarly select components based on correlations between their associated time and mass, by using interactive correlation displays 1602 or 1603 respectively. FIG. 22 enlarges these areas of interest for better view.

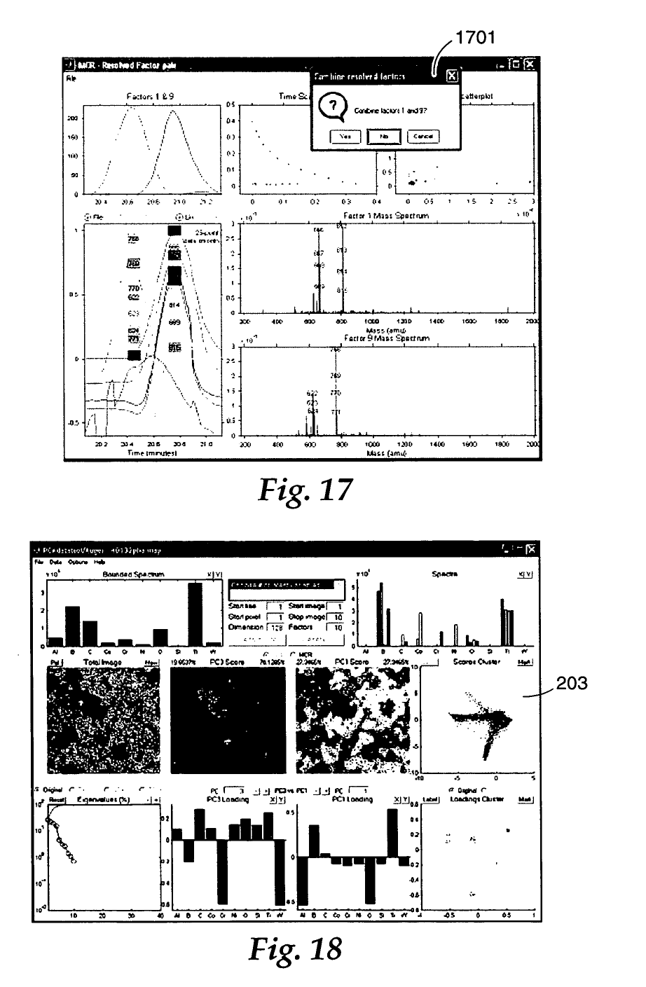

FIG. 17 shows user interface 13 after user 12 has selected a set of components displaying a certain pattern of correlation, as could be done in FIG. 16. After user 12 inspects the various data, user 12 may indicate his desire to combine the components by selecting the appropriate box in combined restored components dialog 1701.

FIG. 18 shows user interface 13, particularly interactive principal component scatter plot 203 showing a PCA scatter plot, before data exploration/visualization module 14 has calculated and color-coded clusters using MCR scatter plot techniques.

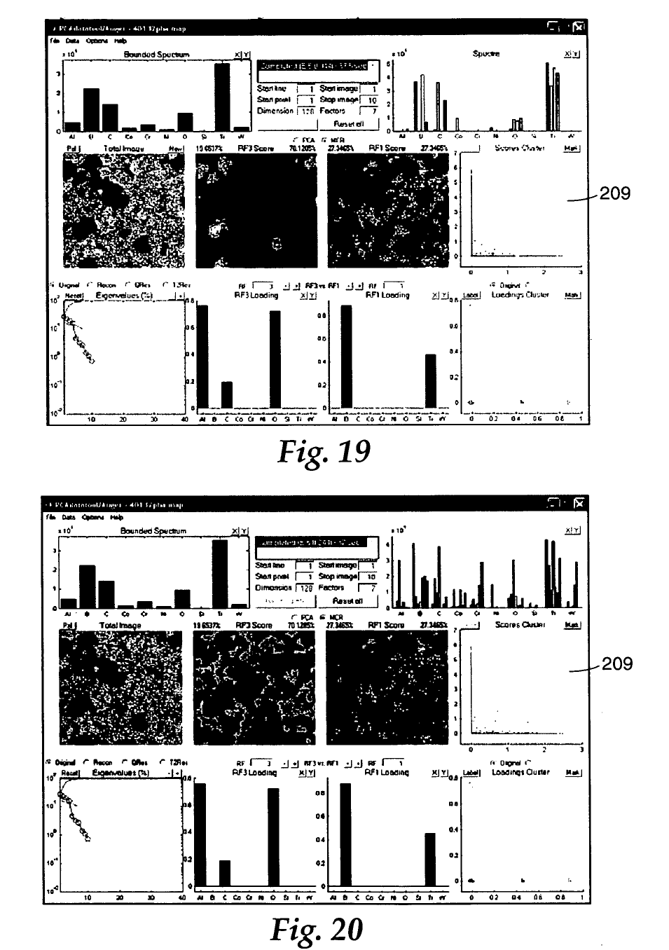

FIG. 19 shows user interface 13, particularly interactive resolved component scatter plot 209 showing an MCR scatter plot, before data exploration/visualization module 14 has used MCR scatter plot techniques to calculate and color-code component clusters, which lie substantially along axes.

FIG. 20 shows user interface 13, particularly interactive resolved component scatter plot 209 showing an MCR scatter plot, after data exploration/visualization module 14 has used MCR scatter plot techniques to calculate and color-code component clusters, which lie substantially along axes.

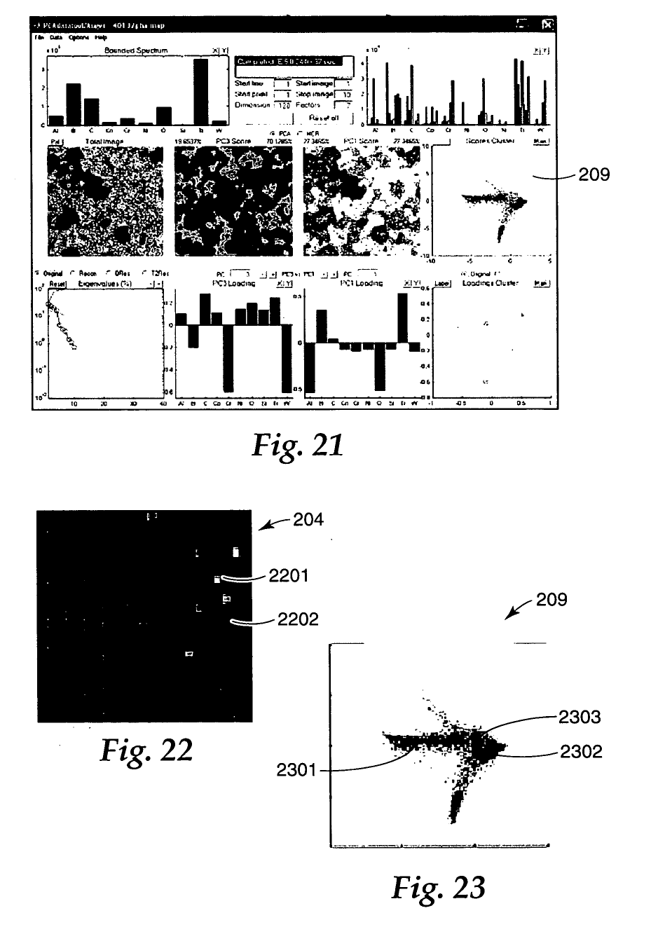

FIG. 21 shows user interface 13, particularly interactive resolved factor scatter plot 209 showing a PCA scatter plot, after data exploration/visualization module 14 has determined visual indicia in the form colorings via MCR scatter plot techniques, and user 12 has switched to PCA scatter plot mode (versus MCR scatter plot mode). FIG. 23 enlarges an area of interest in FIG. 21.

FIG. 22 illustrates in further detail an exemplary factor correlation matrix constructed by the data exploration/visualization module to provide visual indicia representing a degree of correlation between each resolved component pair. In this particular example, the system is programmed such that lighter shades of black are associated with higher correlations (2201). Darker cells are associated with baseline correlation (2202)

FIG. 23 illustrates in further detail an exemplary PCA scatter plot auto-colored by the data exploration/visualization module. In this example, visual indicia in the form of colors have been assigned to clusters with MCR scatter plot techniques, resulting in the blue (2301), red (2302), and yellowish-green (2303). The scatter plot is built up with components contributing least to data variance (for example, the cluster represented by blue (2301)), to components contributing most to data variance, such that the most significant contributors to data variance are over-colored and visually dominate the other components (2303).

Various embodiments of the invention have been described. These and other embodiments are within the scope of the following claims.

1. A computer-implemented method comprising:
receiving Multivariate Curve Resolution (MCR) data having a plurality of components to identify a set of combinations of the components, wherein each of the combinations includes at least two of the components; and
presenting a user interface having an input region associated with each of the combinations, wherein each of the input regions has a visual indicium generated as a function of a degree of correlation between components in the respective combination.

2. The method of claim 1, further comprising:
for each combination, calculating the degree of correlation between each of the respective components.

3. The method of claim 2, wherein calculating the degree of correlation between each of the respective components comprises invoking a statistical engine.

4. The method of claim 1, wherein presenting a user interface comprises:
displaying a matrix having a plurality of cells, wherein each cell comprises a different one of the input regions and represents a different one of the combinations of components.

5. The method of claim 4, wherein presenting a user interface comprises:
generating the input region associated with each of the cells to output the visual indicium based on the degree of correlation between the components of the combination.

6. The method of claim 1, wherein the visual indicium associated with each of the input regions is a color selected from a plurality of colors.

7. The method of claim 1, further comprising:
receiving input defining a selection of one of the input regions; and
displaying data related to the components of the combination associated with the selected input region.

8. The method of claim 7, further comprising:
receiving a request to combine the components of the MCR data; and
in response to the request, combining the components of the combination associated with the selected input region.

9. The method of claim 1, further comprising processing a multivariate data set to identify the plurality of components.

10. The method of claim 9, wherein processing a multivariate data set comprises performing statistical analysis on the multivariate data set to produce MCR data having the plurality of components.

11. The method of claim 9, wherein the statistical analysis comprises:
invoking a statistical engine to apply one or more statistical functions to the multivariate data set to produce the MCR data.

12. The method of claim 11, wherein the statistical function or functions include at least applying Multivariate Curve Resolution to produce the plurality of components.

13. A system comprising:
a module executing on a computer system to access Multivariate Curve Resolution (MCR) data having a plurality of components and correlation data for combinations of said components; and,
a module executing on the computer to present a user interface having an input region associated with each of the combinations, wherein each of the input regions has a visual indicium generated as a function of a degree of correlation for the respective combination.

14. The system of claim 13, further comprising:
a module executing on the computer to identify one or more combinations of the components and caculate the degree of correlation between the combinations of components.

15. (canceled)

16. (canceled)

17. The system of claim 13, wherein the imput region may be selected by clicking on its visual indicium.

18. The system of claim 13, wherein each visual indicium comprises shades of a color.

19. The system of claim 13, wherein each visual indicium comprises one of a plurality of colors.

20. The system of claim 18 or 19, further comprising;
a module executing on the computer system to present a matrix containing a plurality of visual indicia of input regions.

21. The system of claim 13, further comprising:
a module executing on the computer to display data on the combination of components once a combination has been selected.

22. The system of claim 21, further comprising:
a component combination module executing on the computer to combine the components that make up the selected combination.

23. A computer-readable medium comprising computer-readable instruction for causing a programmable processor to:
access Multivariate Curve Resolution (MCR) data having a plurality of components;
identify at least one set of combinations of the plurality of components, wherein each of the combinations includes at least two of the components:
caculate the degree of correlation between each of the components in each combination; and
present a user interface having an input region associated with each of the combinations, wherein each of the input regions has a visual indicium generated as a function of a degree of correlation for the respective combination.

24. The computer-readable medium of claim 23, wherein calculating the degree of correlation between each of the respective components comprises invoking a statistical engine.

25. The computer-readable medium of claim 23, wherein presenting a user interface comprises:
for each of the combinations, selecting the visual indicium from a plurality of visual indicia based on the degree of correlation between the components of the combination.

26 The computer-readable medium of claim 23, wherein presenting a user interface comprises:
displaying a matrix having a plurality of cells, wherein each cell comprises a different one of the input regions and represents a different one of the combinations of components.

27. The computer-readable medium of claim 26, wherein presenting a user interface comprises:
generating the input region associated with each of the cell to output the visual indicium based on the degree of correlation between the components of the combination.

28. The computer-readable medium of claim 23, wherein the visual indicium associated with each of the input regions is a color or shade of color selected from a plurality of colors or shades of colors.

29. The computer-readable medium of claim 23, further comprising:
receiving selection input defining a selection of one of the input regions; and
displaying data related to the combination of components associated with the selection input.

30. The computer-readable medium of claim 29, further comprising:
receiving a request to combine the components of the MCR data; and
in response to the request, combining the components of the combination associated with the selected input region.

31. The computer-readable medium of claim 23, further comprising processing a multivariate data set to identify the plurality of components.

32. The computer-readable medium of claim 31, wherein processing a multivariate data set comprises performing statistical analysis on the multivariate data set to produce MCR data having the plurality of components.

33. The computer-readable medium of claim 31, wherein processing the multivariate data comprises:
invoking a statistical engine to apply one or more statistical functions to the multivariate data set to produce the MCR data.

34. The computer-readable medium of claim 33, wherein the statistical function or functions include at least applying Multivariate Curve Resolution to produce the plurality of components.

35. A system comprising:
a data storage module containing Multivariate Curve Resolution (MCR) data having a plurality of components and correlation data for combination of components;
a module executing on a computer to access the MCR data;
a module executing on the computer to present a user interface having an input region associated with each of the combinations, wherein each of the input regions has a visual indicium generated as a function of a degree of correlation for the resective combination; and
a module executing on the computer to identify one or more combinations of the components and caculate the degree of correlation between the combinations of components.

36. A system comprising:
a numerical analysis module executing on a computer to apply one or more statistical functions to a multivariate data set to produce Multivariate Curve Resolution (MCR) data having a plurality of components and correlation data for combinations of said components;
a module executing on a computer to access the MCR data; and,
a module executing on the computer to present a user interface having an input region associated with each of the combinations, wherein each of the input regions has a visual indicium generated as a function of a degree of correlation for the respective combination.
